(19) United States
(12) Patent Application Publication
(10) Pub. No.: US 2024/0346328 A1
(43) Pub. Date: Oct. 17, 2024

(54) SURVEILLANCE USING TRANSFER LEARNING OF A FEDERATED MODEL

(71) Applicant: Micron Technology, Inc., Boise, ID (US)

(72) Inventors: Shashank Bangalore Lakshman, Folsom, CA (US); Pavana Prakash, Houston, TX (US); Poorna Kale, Folsom, CA (US)

(21) Appl. No.: 18/624,754

(22) Filed: Apr. 2, 2024

Related U.S. Application Data
(60) Provisional application No. 63/458,742, filed on Apr. 12, 2023.

(51) Int. Cl. G06N 3/098; G06Q 30/04; G06V 20/52

(52) U.S. Cl. CPC G06N 3/098; G06V 20/52; G06Q 30/04

(57) ABSTRACT

Network video recorders (NVRs) can be configured to receive video data from operation in a location, train an artificial neural network (ANN) surveillance model with the video data, and provide updates to the ANN surveillance model to a server. The server can be configured to aggregate the updates into a federated ANN surveillance model. The server can deploy the federated ANN surveillance model to the NVRs. The server can train, via transfer learning based on the federated ANN surveillance model, a different ANN surveillance model for a different NVR in a different location. The server can deploy the different ANN surveillance model to the different NVR.

### PRIORITY INFORMATION

This application claims the benefits of U.S. Provisional Application No. 63/458,742, filed on Apr. 12, 2023, the contents of which are incorporated herein by reference.

### TECHNICAL FIELD

The present disclosure relates generally to apparatuses, non-transitory machine-readable media, and methods associated with surveillance using transfer learning of a federated model.

### BACKGROUND

A computing device can be, for example, a personal laptop computer, a desktop computer, a server, a smart phone, smart glasses, a tablet, a wrist-worn device, a mobile device, a digital camera, and/or redundant combinations thereof, among other types of computing devices. Computing devices can be used to implement artificial neural networks (ANNs). Computing devices can also be used to train the ANNs.

ANNs are networks that can process information by modeling a network of neurons, such as neurons in a human brain, to process information (e.g., stimuli) that has been sensed in a particular environment. Similar to a human brain, neural networks typically include a multiple neuron topology, which can be referred to as artificial neurons. An ANN operation refers to an operation that processes inputs using artificial neurons to perform a given task. The ANN operation may involve performing various machine learning algorithms to process the inputs. Example tasks that can be processed by performing ANN operations can include machine vision, speech recognition, machine translation, social network filtering, and medical diagnosis, among others.

### BRIEF DESCRIPTION OF THE DRAWINGS

FIG. 1 is a block diagram of a system for surveillance using transfer learning of a federated model.

FIG. 2 is a functional block diagram for surveillance using transfer learning of a federated model.

FIG. 3 is a flow diagram corresponding to a method for surveillance using transfer learning of a federated model.

FIG. 4 is a block diagram of a computer system in which embodiments may operate.

### DETAILED DESCRIPTION

The present disclosure describes apparatuses and methods related to surveillance using transfer learning of a federated model. A federated model is an ANN model that is trained and/or updated by federated learning. As used herein, “federated learning” refers to an approach to training an ANN across multiple decentralized edge devices using local datasets without exchanging the local datasets between the decentralized edge devices. In contrast to other approaches in which local datasets are uploaded to a host system (e.g., a server) or that assume identical distribution of the local datasets, federated learning can enable multiple devices to individually contribute to the generation of a common, robust machine learning model without sharing data between the local devices. This can also avoid the need for large server farms to provide the necessary compute and memory resources to perform the training. As a result, issues, such as data privacy, data security, data access rights, and access to heterogeneous data, for example, can be addressed.

Transfer learning includes the use of stored knowledge gained while solving one problem in machine learning and applying it to a different but related problem. A machine learning model developed for one task is reused as the starting point for a model to perform a related, but different task. One advantage of transfer learning is that it can allow a pretrained model to be used to perform a different task, which is much less resource intensive than training a new model for the different task. The transfer learning model can be further refined with additional training on a data set related to the different task.

Federated learning can include a host system communicating (e.g., broadcasting) an initial model to multiple devices. In federated learning, one or more local datasets are used to train and/or retrain the initial model on the local devices. Local versions (e.g., updated versions) of the initial model or just the updates themselves (e.g., updated weights, biases, activation functions, etc. of the model) are communicated from one or more of the local devices to the host system. The host system can aggregate the updates from multiple local devices into a federated model, which can be communicated from the host system to the local devices. The communication of the federated model can include transmitting signals indicative of the entire federated model or only updated portions of the federated model (e.g., updated weights, biases, activation functions, etc.).

The local devices can be cameras such as network video recorders (NVRs). NVRs can act as standalone smart surveillance systems powered by artificial intelligence (AI) in high-risk, security-vulnerable areas such as factory environments. However, the quality of the machine learning model depends on the size of the training dataset of the system, which in turn is dependent on the placement of the NVRs. For example, NVRs placed in isolated or remote locations may have a smaller dataset due to less camera traffic and activity, making them unsuitable for building robust machine learning models for standalone surveillance. However, sharing datasets from other devices can be problematic in terms of data privacy and/or communication bandwidth.

Embodiments of the present disclosure address the above deficiencies and other deficiencies of previous approaches by applying a two-step learning process. First, leveraging a close-knit network of NVRs with heterogeneous data, an initial ANN surveillance model can be trained and updated into a federated ANN surveillance model. The processing resources and/or memory resources of the NVRs can be repurposed and utilized to train an ANN surveillance model. The NVRs can perform training using their local computational resources. Instead of sharing private datasets (e.g., camera footage), only the local model updates are uploaded to the server. Such updates can occur over multiple rounds of learning using local training datasets (e.g., the footage captured by individual NVRs). The server can aggregate the updates across multiple NVRs and/or multiple rounds of training into a federated ANN surveillance model. The server can be local to a particular installation, such as a factory, and/or global across multiple different security installations.

Second, the learned information (federated ANN surveillance model) can be transferred to isolated NVRs using transfer learning. This can create a target ANN surveillance model that is trained with the heterogeneous knowledge of varied devices without accessing other datasets. This can enable deployment of standalone smart surveillance.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

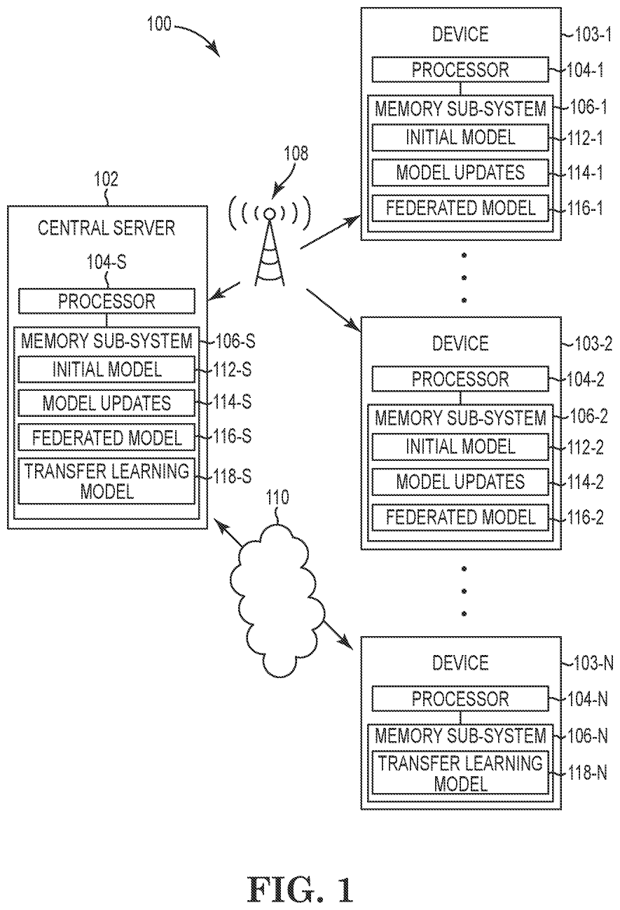

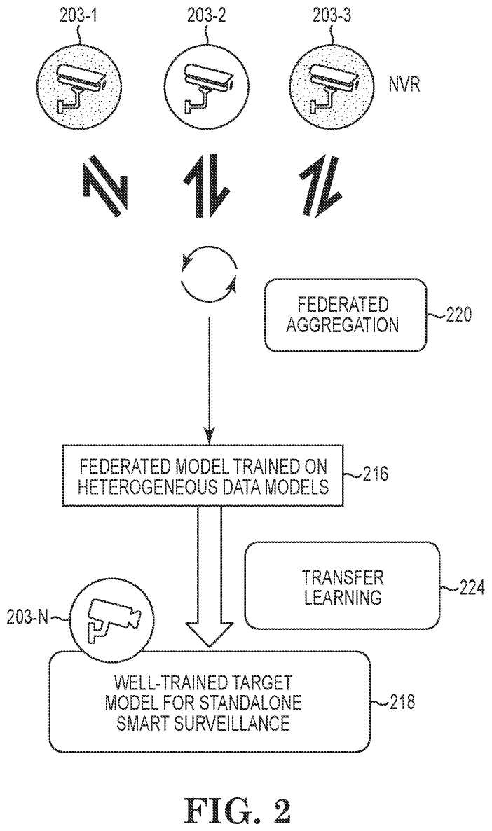

The figures herein follow a numbering convention in which the first digit or digits correspond to the drawing figure number and the remaining digits identify an element or component in the drawing. Similar elements or components between different figures may be identified by the use of similar digits. For example, 103-1 may reference element “03” in FIG. 1, and a similar element may be referenced as 203-1 in FIG. 2. Analogous elements within a Figure may be referenced with a hyphen and extra numeral or letter. See, for example, elements 103-1, 103-2, . . . , 103-N in FIG. 1. Such analogous elements may be generally referenced without the hyphen and extra numeral or letter. For example, elements 103-1, . . . , 103-N may be collectively referenced as 103. As used herein, the designators “N” and “S”, particularly with respect to reference numerals in the drawings, indicates that a number of the particular feature so designated can be included. As will be appreciated, elements shown in the various embodiments herein can be added, exchanged, and/or eliminated so as to provide a number of additional embodiments. In addition, as will be appreciated, the proportion and the relative scale of the elements provided in the figures are intended to illustrate certain embodiments of the present invention and should not be taken in a limiting sense.

FIG. 1 is a block diagram of a system 100 for surveillance using transfer learning of a federated model. The system 100 can comprise a server 102 and devices 103-1, 103-2, . . . , 103-N (e.g., NVRs). The system 100, the server 102, and the NVRs 103 can comprise hardware, firmware, and/or software configured to train an ANN model. As used herein, an ANN model can include a plurality of weights, biases, and/or activation functions among other variables that can be used to execute an ANN. The server 102 and the NVRs 103 can further include memory sub-systems 106-1, 106-2, 106-N, 106-S (e.g., a non-transitory MRM), on which may be stored instructions and/or data. Although the following descriptions refer to a processing device and a memory device, the descriptions may also apply to a system with multiple processing devices and multiple memory devices. In such examples, the instructions may be distributed (e.g., stored) across multiple memory devices and the instructions may be distributed (e.g., executed by) across multiple processing devices.

The memory sub-systems 106 can be memory devices. The memory devices can be electronic, magnetic, optical, or other physical storage devices that store executable instructions. The memory devices can include non-volatile or volatile memory. In some examples, the memory device is a non-transitory MRM comprising random access memory (RAM), an Electrically-Erasable Programmable read only memory (EEPROM), a storage drive, an optical disc, and the like. Executable instructions (e.g., training instructions, aggregation instructions, transfer learning instructions, etc.) can be “installed” on the server 102 and/or the NVRs 103. The memory sub-systems 106 can be portable, external, or remote storage mediums, for example, that allow the server 102 and/or the NVRs 103 to download the instructions from the portable/external/remote storage mediums. In this situation, the executable instructions may be part of an “installation package.” As described herein, the memory sub-systems 106 can be encoded with executable instructions for training an ANN, aggregating updates to an ANN, and providing transfer learning for a different ANN, among other functions described herein.

The server 102 can execute instructions using the processor 104-S. The instructions can be stored in the memory sub-system 106-S prior to being executed by the processor 104-S. The execution of the instructions can cause the initial model 112-S to be provided to the NVRs 103-1, 103-2 (any number of NVRs 103).

The NVRs 103 can store and train the initial model 112. Specifically, a first NVR 103-1 can store and train a first copy of the initial model 112-1 and a second NVR 103-2 can store and train a second copy of the initial model 112-2. Although only two NVRs 103 are illustrated as storing and training the initial model 112, any number of NVRs may do so in practice. In one example, the NVRs 103-1, 103-2 (any number of NVRs) are components of a discrete surveillance system and the different NVR 103-N is not part of the discrete surveillance system. The term “discrete surveillance system” means a surveillance system that is commonly owned, controlled, and/or is part of the same facility. In another example, the NVRs 103-1, 103-2, 103-N are all part of the same discrete surveillance system, but the NVR 103-N is in a low density traffic area as compared to the NVRs 103-1, 103-2, which receive much more activity on video and are therefore better able to train the initial model 112 than the NVR 103-N. In some examples, the NVR 103-N can be a standalone NVR while the NVR 103-1 represents one of many NVRs that are part of a first discrete surveillance system and the NVR 103-2 represents one of many NVRs that are part of a second discrete surveillance system. In at least one example, each of the NVRs 103-1, 103-2, 103-N represents one or more NVRs in different discrete surveillance systems. In each example, the NVR 103-N represents an NVR that, for whatever reason, does not receive enough traffic to provide sufficient video data to train an ANN surveillance model as adequately as the remaining NVRs 103-1, 103-2.

The initial model 112 can be an initial ANN surveillance model 112, which may be referred to herein as an initial model for simplicity. Although not specifically illustrated, the NVRs 103 can each receive respective video data from operation in a respective location. The NVRs 103 can store the respective video data and/or train the initial model 112 with the respective video data. As a result of training the initial model 112, the NVRs 103 can store respective model updates 114-1, 114-2. The model updates 114 can represent corrections (e.g., training feedback) for the initial model 112, which can comprise or be used to modify the weights, biases, and/or activation functions of the initial model 112. Although, in some examples, the model updates 114 represent an entirety of the initial model 112 with a local update by a particular NVR 103 incorporated therein. The NVRs 103 can provide the respective model updates 114-1, 114-2 to the server 102, which can store the model updates 114-S. However, the NVRs, in some examples, are configured not to send the video data to the server 102 in order to keep such data secure. The server 102 does not represent a central monitoring system (e.g., in the event that any of the NVRs 103 is connected to a central monitoring system, which may include a server, for example, to provide monitoring of a large facility). The NVRs 103, although configured not to send video data to the server 102, may be configured to send video data to a central monitoring system, if so equipped.

The NVRs 103-1, 103-2 can train the initial model 112 by executing instructions using the processors 104-1, 104-2. Although not specifically illustrated, the NVRs 103 can include artificial intelligence (AI) accelerators such as deep learning accelerators (DLAs), which can be utilized to train ANN models. As used herein, AI refers to the ability to improve an apparatus through “learning” such as by storing patterns and/or examples which can be utilized to take actions at a later time. Deep learning refers to a device's ability to learn from data provided as examples. Deep learning can be a subset of AI. Neural networks, among other types of networks, can be classified as deep learning. In various examples, processors 104 are described for performing the examples described herein. AI accelerators can also be utilized to perform the examples described herein instead of or in concert with the processors 104. The NVRs 103 can provide a first surveillance function according to operation of the initial model 112, for example, by executing the initial model 112 utilizing the processors 104. In various examples, the processors 104 can be internal to the memory sub-systems 106 instead of being external to the memory sub-systems 106 as shown. For instance, the processors 104 can be processor-in-memory (PIM) processors. The processors 104 can be incorporated into the sensing circuitry of the memory sub-systems 106 and/or can be implemented in the periphery of the memory sub-system 106, for instance. The processors 104 can be implemented under one or more memory arrays of the memory sub-system 106.

Training an ANN model can include a forward pass (e.g., forward propagation) of the ANN model and a loss back propagation (e.g., backward propagation) through the ANN model. A loss calculation utilizing the output of the ANN model can be performed. The loss calculation (e.g., loss function) can be used to measure how well the ANN model models the training data. Training minimizes a loss between the output of the ANN model and the target outputs. Hyperparameters (e.g., weights, biases, and/or activation functions) can be adjusted to minimize the average loss between the output of the ANN model and the target output. The hyperparameters of the ANN model can be adjusted by the devices 103 and/or the server 102. Other training methods can be used.

The loss function can be any one of a number of loss functions. For example, the loss function can be a mean square error loss function or a mean absolute error loss function. Back propagation includes computing the gradient of the loss function with respect to the weights of the ANN model for a single input-output example. Gradient algorithms can be used for training multilayer ANN models, updating weights to minimize loss, for example, using gradient descent or variants such as stochastic gradient descent. Back propagation works by computing the gradient of the loss function with respect to each weight by the chain rule. The chain rule can describe the computing of the gradient one layer at a time.

The server 102 can aggregate the respective updates 114-S into a federated ANN surveillance model 116-S, which may be referred to herein as a federated model 116 for simplicity. The server 102 can use any method of aggregating the respective updates 114, such as averaging, weighted averaging (e.g., based on differences in processing power of the NVRs 103 from which updates 114 are received, based on an amount of training data used by the NVRs 103 to create the updates, or other methods of weighted averaging), etc. The server 102 can deploy copies of the federated model 116-1, 116-2 to the NVRs 103-1, 103-2. The NVRs 103-1, 103-2 can execute the federated model 116 to provide a surveillance function. The NVRs 103-1, 103-2 can be configured to operate according to the federated model 116.

The server 102 can train, via transfer learning based on the federated model 116-S, a different ANN surveillance model 118-S, which is a transfer learning ANN surveillance model 118-S, for a different NVR 103-N in a different location. The server 102 can deploy the transfer learning model 118-S to the different NVR 103-N, which can store the transfer learning model 118-N. The NVR 103-N can provide a surveillance function according to operation of the transfer learning model 118-N, for example, by executing the transfer learning model 118-N utilizing the processor 104-N. In some embodiments, the surveillance function provided by operation of the transfer learning model 118-N is different than the surveillance function provided by execution of the federated model 116 and/or the initial model 112. In some embodiments, the surveillance function provided by operation of the transfer learning model 118-N is the same as the surveillance function provided by execution of the federated model 116 and/or the initial model 112, but the transfer learning model 118-N is fine-tuned for operation in the different location where the different NVR 103-N is situated versus the NVRs 103-1, 103-2. The NVR 103-N can be configured to operate according to the transfer learning model 118-N.

The server 102 can be configured to charge an entity that controls the NVRs 103 for the federated model 116-5 and/or the transfer learning model 118-5. Different entities can be charged different prices. Different prices can be charged for different models. For example, a first price can be charged for the federated model 116-1 to a first entity that controls a first discrete surveillance system that includes the first NVR 103-1, a second price can be charged for the federated model 116-2 to a second entity that controls the second NVR 103-2, and a third price can be charged for the transfer learning model 118-N to a third entity that controls a third discrete surveillance system that includes the third NVR 103-N. Other price arrangements are possible, some of which are described herein.

FIG. 2 is a functional block diagram for surveillance using transfer learning of a federated model. An apparatus, such as the server 102 illustrated in FIG. 1, can be configured to deploy a first ANN surveillance model to a plurality of NVRs 203-1, 203-2, 203-3 . . . . The apparatus can be configured to receive respective updates to the first ANN surveillance model from each of the plurality of NVRs 203-1, 203-2, 203-3 that have trained the first ANN surveillance model. As illustrated at 220, the apparatus can aggregate the respective updates into a federated ANN surveillance model 216. The apparatus can deploy the federated ANN surveillance model to the plurality of NVRs 203-1, 203-2, 203-3.

As illustrated at 224, the apparatus can train, via transfer learning based on the federated ANN surveillance model, a second ANN surveillance model 218 for a different NVR 203-N. The second ANN surveillance model 218 can be a well-trained target model for standalone smart surveillance. The second ANN surveillance model 218 can be trained to perform a different surveillance function than the first ANN surveillance model. The different NVR 203-N can be a single camera for a particular facility. As another example, the different NVR 203-N can represent more than one camera for the particular facility. The particular facility can have a different surveillance system than that associated with the plurality of NVRs 203-1, 203-2, 203-3. In these examples, the particular facility does not include the plurality of NVRs 203-1, 203-2, 203-3, and therefore their training and/or federated model 216 may not operate as efficiently as desired on the standalone NVR 203-N. Therefore, transfer learning 224 can be used to improve the federated model 216 before it is deployed to the standalone NVR 203-N.

The apparatus, or a different apparatus, can be configured to charge a first price to a first entity controlling the NVRs 203-1, 203-2, 203-3 for deployment of the federated ANN surveillance model 216 to each of the NVRs 203-1, 203-2, 203-3. A second price can be charged to a second entity controlling the different NVR 203-N for deployment of the different ANN surveillance model 218 to the different NVR 203-N. For example, the second price can be greater than the first price because the transfer learning model 218 required additional training beyond that required for the federated model 216.

The NVRs 203-1, 203-2, 203-3 can be part of a first discrete surveillance system. The apparatus can be configured to receive second respective updates from each of a second plurality of NVRs (not specifically illustrated in FIG. 2) that are components of a second discrete surveillance system. The apparatus can aggregate the second respective updates with the respective updates (received from the NVRs 203-1, 203-2, 203-3) that were aggregated into the federated ANN surveillance model 216. Because any NVR 203 in the system is configured to send model updates without sending underlying data, aggregating updates across different surveillance systems should not pose a data security concern for different discrete surveillance systems. Different prices can be charged to different entities controlling different discrete surveillance systems, even if the same federated ANN surveillance model is deployed to NVRs of the different systems.

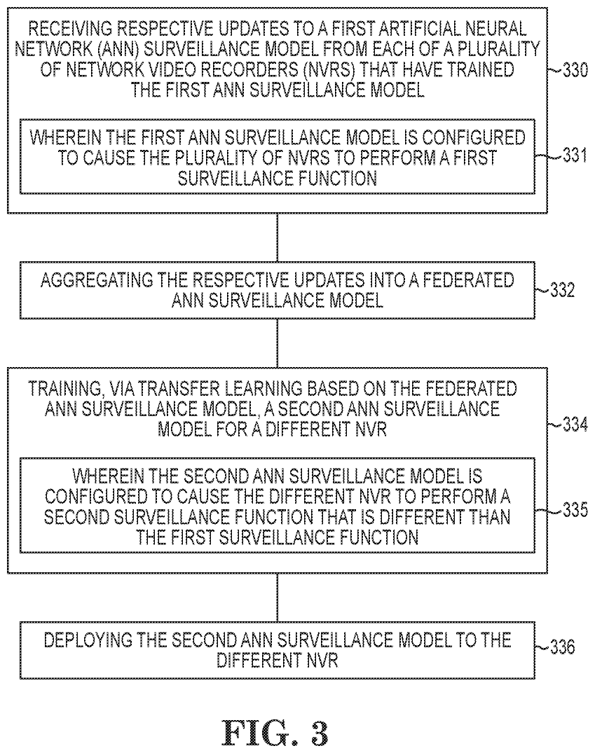

FIG. 3 is a flow diagram corresponding to a method for surveillance using transfer learning of a federated model. The method may be performed, in some examples, using a computing system such as those described with respect to FIG. 1. The method can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by or using the server 102 and/or the devices 103 shown in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At 330, a method can include receiving respective updates to a first ANN surveillance model from each of a plurality of NVRs that have trained the first ANN surveillance model. The updates can be received without receiving video data from the plurality of NVRs. As illustrated at 331, the first ANN surveillance model can be configured to cause the plurality of NVRs to perform a first surveillance function.

At 332, the method can include aggregating the respective updates into a federated ANN surveillance model. Although not specifically illustrated, the method can include deploying the federated ANN surveillance model to the plurality of NVRs. The federated ANN surveillance model is configured to cause the plurality of NVRs to perform the first surveillance function, albeit in a more efficient or otherwise better manner than the initial ANN surveillance model due to the federated learning that has occurred.

At 334, the method can include training, via transfer learning based on the federated ANN surveillance model, a second ANN surveillance model for a different NVR. The second ANN surveillance model can be configured to cause the different NVR to perform a second surveillance function that is different than the first surveillance function.

At 336, the method can include deploying the second ANN surveillance model to the different NVR. Although not specifically illustrated, the method can include charging a first entity controlling the plurality of NVRs a first price for deployment of the federated ANN surveillance model to each of the plurality of NVRs and charging a second entity controlling the different NVR a second price for deployment of the second ANN surveillance model to the different NVR.

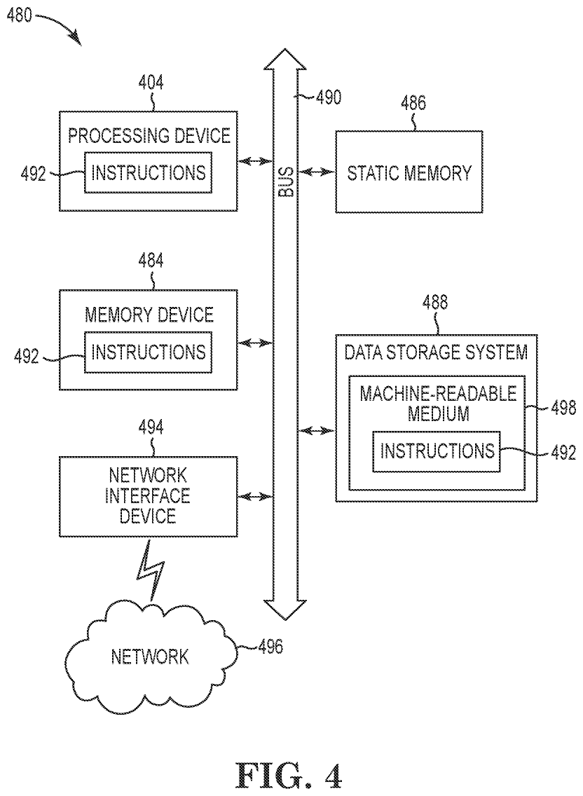

FIG. 4 is a block diagram of a computer system 480 in which embodiments may operate. Aa set of instructions for causing a machine to perform any of the methodologies discussed herein can be executed within the computer system 480. In some embodiments, the computer system 480 can correspond to a host system that includes, is coupled to, or utilizes a memory sub-system (e.g., the memory sub-systems 106-1, 106-2, 106-N, 106-S of FIG. 1). The computer system 480 can be used to perform the operations described herein (e.g., to perform operations by the processors 104-1, 104-2, 104-N, 104-S of FIG. 1). In alternative embodiments, a machine can be connected (e.g., networked) to other machines in a local area network (LAN), an intranet, an extranet, the Internet, and/or wireless network. A machine can operate in the capacity of a server or a client machine in client-server network environment, as a peer machine in a peer-to-peer (or distributed) network environment, or as a server or a client machine in a cloud computing infrastructure or environment.

A machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. The term “machine” shall also be taken to include any collection of machines that individually or jointly execute a set (or multiple sets) of instructions to perform any one or more of the methodologies discussed herein.

The computer system 480 includes a processing device (e.g., processor) 404, a main memory 484 (e.g., read-only memory (ROM), flash memory, dynamic random access memory (DRAM) such as synchronous DRAM (SDRAM) or Rambus DRAM (RDRAM), etc.), a static memory 486 (e.g., flash memory, static random access memory (SRAM), etc.), and a data storage system 488, which communicate with each other via a bus 490.

The processing device 404 represents one or more general-purpose processing devices such as a microprocessor, a central processing unit, or the like. More particularly, the processing device 404 can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 404 can also be one or more special-purpose processing devices such as an application specific integrated circuit (ASIC), a field programmable gate array (FPGA), a digital signal processor (DSP), network processor, or the like. The processing device 404 is configured to execute instructions 492 for performing the operations and steps discussed herein. The computer system 480 can further include a network interface device 494 to communicate over the network 496.

The data storage system 488 can include a machine-readable storage medium 498 (also known as a computer-readable medium) on which is stored one or more sets of instructions 492 or software embodying any one or more of the methodologies or functions described herein. The instructions 492 can also reside, completely or at least partially, within the main memory 484 and/or within the processing device 404 during execution thereof by the computer system 480, the main memory 484 and the processing device 404 also constituting machine-readable storage media. The machine-readable storage medium 498, data storage system 488, and/or main memory 484 can correspond to the memory sub-systems 106-1, 106-2, 106-N, 106-S of FIG. 1.

In one embodiment, the instructions 492 include instructions to implement functionality corresponding to surveillance using transfer learning of a federated model. While the machine-readable storage medium 499 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies described herein. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

Embodiments also relate to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

Embodiments can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a ROM, RAM, magnetic disk storage media, optical storage media, flash memory devices, etc.

In the foregoing specification, embodiments have been described with reference to specific example embodiments thereof. It will be evident that various modifications can be made thereto without departing from the broader spirit and scope of embodiments as set forth in the following claims. The specification and drawings are, accordingly, to be regarded in an illustrative sense rather than a restrictive sense.

What is claimed is:

1. A method, comprising:
receiving respective updates to a first artificial neural network (ANN) surveillance model from each of a plurality of network video recorders (NVRs) that have trained the first ANN surveillance model;
wherein the first ANN surveillance model is configured to cause the plurality of NVRs to perform a first surveillance function;
aggregating the respective updates into a federated ANN surveillance model;
training, via transfer learning based on the federated ANN surveillance model, a second ANN surveillance model for a different NVR;
wherein the second ANN surveillance model is configured to cause the different NVR to perform a second surveillance function that is different than the first surveillance function; and
deploying the second ANN surveillance model to the different NVR.

2. The method of claim 1, further comprising deploying the federated ANN surveillance model to the plurality of NVRs.

3. The method of claim 2, wherein the federated ANN surveillance model is configured to cause the plurality of NVRs to perform the first surveillance function.

4. The method of claim 2, further comprising:
charging a first entity controlling the plurality of NVRs a first price for deployment of the federated ANN surveillance model to each of the plurality of NVRs; and
charging a second entity controlling the different NVR a second price for deployment of the second ANN surveillance model to the different NVR.

5. The method of claim 1, wherein receiving the respective updates comprises receiving the respective updates to the first ANN without receiving video data from the plurality of NVRs.

6. An apparatus comprising:
a memory;
a processor coupled to the memory and configured to:
receive respective updates to a first artificial neural network (ANN) surveillance model from each of a plurality of network video recorders (NVRs) that have trained the first ANN surveillance model;
aggregate the respective updates into a federated ANN surveillance model;
deploy the federated ANN surveillance model to the plurality of NVRs;
train, via transfer learning based on the federated ANN surveillance model, a second ANN surveillance model for a different NVR; and
deploy the second ANN surveillance model to the different NVR;
wherein the different NVR is part of a different surveillance system than the plurality of NVRs.

7. The apparatus of claim 6, wherein the second ANN surveillance model is trained to perform a different surveillance function than the first ANN surveillance model.

8. The apparatus of claim 6, wherein the processor is further configured to deploy the ANN surveillance model to the plurality of NVRs prior to receiving the respective updates.

9. The apparatus of claim 6, wherein the processor is further configured to:
charge a first price to a first entity controlling the plurality of NVRs for deployment of the federated ANN surveillance model to each of the plurality of NVRs; and
charge a second price to a second entity controlling the different NVR for deployment of the different ANN surveillance model to the different NVR.

10. The apparatus of claim 6, wherein the plurality of NVRs are components of a first discrete surveillance system;
wherein the processor is further configured to:
receive second respective updates to the ANN surveillance model from each of a second plurality of NVRs that are components of a second discrete surveillance system; and
aggregate the second respective updates with the respective updates into the federated ANN surveillance model.

11. The apparatus of claim 10, wherein the processor is further configured to:
charge a first price to a first entity controlling the plurality of NVRs for deployment of the federated ANN surveillance model to each of the plurality of NVRs;
charge a second price to a second entity controlling the second plurality of NVRs for deployment of the federated ANN surveillance model to each of the second plurality of NVRs; and
charge a third price to a third entity controlling the different NVR for deployment of the different ANN surveillance model to the different NVR.

12. A system, comprising:
a plurality of network video recorders (NVRs), each configured to:
receive respective video data from operation in a respective location;
train a respective artificial neural network (ANN) surveillance model with the respective video data; and
provide respective updates to the respective ANN surveillance model to a server;
the server, configured to:
aggregate the respective updates into a federated ANN surveillance model;
train, via transfer learning based on the federated ANN surveillance model, a different ANN surveillance model for a different NVR in a different location; and
deploy the different ANN surveillance model to the different NVR.

13. The system of claim 12, wherein the plurality of NVRs are further configured to provide a first surveillance function according to operation of the respective ANN surveillance model; and
wherein the different NVR is configured to provide a second surveillance function according to operation of the different ANN surveillance model;
wherein the first surveillance function is different than the second surveillance function.

14. The system of claim 12, wherein the server is further configured to deploy the federated ANN surveillance model to the plurality of NVRs.

15. The system of claim 14, wherein the plurality of NVRs are further configured to operate according to the federated ANN surveillance model.

16. The system of claim 15, wherein the plurality of NVRs are components of a discrete surveillance system; and
wherein the different NVR is not part of the discrete surveillance system.

17. The system of claim 15, wherein a first subset of the plurality of NVRs are components of a first discrete surveillance system;
wherein a second subset of the plurality of NVRs are components of a second discrete surveillance system; and
wherein the different NVR is a standalone NVR.

18. The system of claim 15, wherein a first subset of the plurality of NVRs are components of a first discrete surveillance system;
wherein a second subset of the plurality of NVRs are components of a second discrete surveillance system; and
wherein the different NVR is a component of a third discrete surveillance system.

19. The system of claim 18, wherein the server is further configured to:
charge a first price to a first entity controlling the first discrete surveillance system for the federated ANN surveillance model;
charge a second price to a second entity controlling the second discrete surveillance system for the federated ANN surveillance model; and
charge a third price to a third entity controlling the third discrete surveillance system.

20. The system of claim 12, wherein the plurality of network video recorders (NVRs) are configured not to send the video data to the server.
